(19) United States
(12) Patent Application Publication
(10) Pub. No.: US 2024/0388333 A1
(43) Pub. Date: Nov. 21, 2024

(54) LINK ADAPTATION

(71) Applicant: Nokia Solutions and Networks Oy, Espoo (FI)

(72) Inventors: Pavan KOTESHWAR SRINATH, Orsay (FR); Jakob HOYDIS, Paris (FR)

(73) Assignee: Nokia Solutions and Networks Oy, Espoo (FI)

(21) Appl. No.: 18/687,031

(22) PCT Filed: Aug. 27, 2021
(86) PCT No.: PCT/EP2021/073716

§ 371 Date: Feb. 27, 2024

(51) Int. Cl. H04B 7/0452; H04L 1/00; H04L 25/02

(52) U.S. Cl. CPC H04B 7/0452; H04L 1/0003; H04L 25/0224

(57) ABSTRACT

In one embodiment, an apparatus is configured to perform estimating a channel of a multi-user multiple-input-multiple-output mobile communication system; determining, based on the estimated channel, a metric for each of a plurality of available modulation orders for each of a plurality of transmitting channels of said communication system; identifying, for each transmitting channel, one or more modulation and coding schemes for which the predicted metric meets a target error rate criterion, wherein each modulation and coding scheme comprises a modulation order and a code rate of a channel code; and selecting a modulation and coding scheme for each of said transmitting channels from said identified modulation and coding schemes.

### FIELD

The present specification relates to link adaptation; for example, to link adaptation in multi-user multiple-input-multiple-output (MIMO) mobile communication systems.

### BACKGROUND

Link adaptation can be used to define a modulation and coding scheme (MCS) for communications between a user device and a network node (e.g. a base station) of a mobile communication system. A link adaptation algorithm may seek to define the MCS based, for example, on a capacity that is supported by the link between the user device and the network node. There remains a need for further developments in this field.

### SUMMARY

In a first aspect, this specification describes an apparatus comprising means for performing: estimating a channel (e.g. a channel matrix) of a multi-user multiple-input-multiple-output (MU-MIMO) mobile communication system; determining, based on the estimated channel, a metric for each of a plurality of available modulation orders for each of a plurality of transmitting channels of said communication system; identifying, for each transmitting channel, one or more modulation and coding schemes (MCS) for which the predicted metric meets a target error rate criterion, wherein each modulation and coding scheme comprises a modulation order and a code rate of a channel code; and selecting a modulation and coding scheme for each of said transmitting channels from said identified modulation and coding schemes. Said selecting may be implemented as a joint optimisation problem.

The metrics may comprise bit metric decoding rates (BMDR) or metrics having a one-to-one relationship with bit-metric decoding rates. For example, one bit metric decoding rate may be provided for each modulation order.

In some example embodiments, the metrics are determined using a machine learning model. This is not essential to all example embodiments. For example, for linear detectors, it may be possible to determine said metrics without using a machine learning model.

The said one or more modulation and coding schemes may be identified using a lookup table.

The modulation and coding schemes may be selected jointly for said transmitting channels. Alternatively, or in addition, the modulation and coding schemes may be selected based on an optimisation of spectral efficiency across the transmitting channels.

In some example embodiments, the available modulation orders comprise all modulation orders of a communications standard being implemented by the communication system.

The transmitting channels may relate to transmitter user devices of the communication system.

In some example embodiments, the target error rate criterion comprises a codeword error rate criterion or a block error rate criterion.

The multi-user multiple-input-multiple-output (MU-MIMO) mobile communication system may comprise a non-linear detector (e.g. a non-linear detector used to generate LLRs for each transmitted bit for each user). This is not essential to all example embodiments. For example, the principles describes herein may be applied to linear detectors.

The means may comprise: at least one processor; and at least one memory including computer program code, the at least one memory and computer program code configured to, with the at least one processor, cause the performance of the apparatus.

In a second aspect, this specification describes a method comprising: estimating a channel (e.g. a channel matrix) of a multi-user multiple-input-multiple-output (MU-MIMO) mobile communication system; determining, based on the estimated channel, a metric for each of a plurality of available modulation orders for each of a plurality of transmitting channels of said communication system (which transmitting channels may relate to transmitter user devices of the communication system); identifying, for each transmitting channel, one or more modulation and coding schemes for which the predicted metric meets a target error rate criterion, wherein each modulation and coding scheme comprises a modulation order and a code rate of a channel code; and selecting a modulation and coding scheme for each of said transmitting channels from said identified modulation and coding schemes. Said selecting may be implemented as a joint optimisation problem. The metrics may comprise bit metric decoding rates (BMDR) or metrics having a one-to-one relationship with bit-metric decoding rates. For example, one bit metric decoding rate may be provided for each modulation order.

In some example embodiments, the metrics are determined using a machine learning model.

The said one or more modulation and coding schemes may be identified using a lookup table.

The modulation and coding schemes may be selected jointly for said transmitting channels. Alternatively, or in addition, the modulation and coding schemes may be selected based on an optimisation of spectral efficiency across the transmitting channels.

In some example embodiments, the available modulation orders comprise all modulation orders of a communications standard being implemented by the communication system.

In some example embodiments, the target error rate criterion comprises a codeword error rate criterion or a block error rate criterion.

In a third aspect, this specification describes an apparatus configured to perform (at least) any method as described with reference to the second aspect.

In a fourth aspect, this specification describes computer-readable instructions which, when executed by a computing apparatus, cause the computing apparatus to perform (at least) any method as described with reference to the second aspect.

In a fifth aspect, this specification describes a computer-readable medium (such as a non-transitory computer-readable medium) comprising program instructions stored thereon for performing (at least) any method as described with reference to the second aspect.

In a sixth aspect, this specification describes an apparatus comprising: at least one processor; and at least one memory including computer program code which, when executed by the at least one processor, causes the apparatus to perform (at least) any method as described with reference to the second aspect.

In a seventh aspect, this specification describes a computer program comprising instructions for causing an apparatus to perform at least the following: estimating a channel of a multi-user multiple-input-multiple-output mobile communication system; determining, based on the estimated channel, a metric for each of a plurality of available modulation orders for each of a plurality of transmitting channels of said communication system; identifying, for each transmitting channel, one or more modulation and coding schemes for which the predicted metric meets a target error rate criterion, wherein each modulation and coding scheme comprises a modulation order and a code rate of a channel code; and selecting a modulation and coding scheme for each of said transmitting channels from said identified modulation and coding schemes.

In an eighth aspect, this specification describes an apparatus comprising a channel estimator (or some other means) for estimating a channel (e.g. a channel matrix) of a multi-user multiple-input-multiple-output (MU-MIMO) mobile communication system; a prediction module (or some other means) for determining, based on the estimated channel, a metric for each of a plurality of available modulation orders for each of a plurality of transmitting channels of said communication system (which transmitting channels may relate to transmitter user devices of the communication system); a selection module (or some other means) for identifying (e.g. based on data from an offline generated lookup table), for each transmitting channel, one or more modulation and coding schemes for which the predicted metric meets a target error rate criterion, wherein each modulation and coding scheme comprises a modulation order and a code rate of a channel code; and an optimisation module (or some other means) for selecting a modulation and coding scheme for each of said transmitting channels from said identified modulation and coding schemes.

### BRIEF DESCRIPTION OF DRAWINGS

Example embodiments will now be described, by way of non-limiting examples, with reference to the following schematic drawings, in which:

FIG. 1 is a block diagram of a mobile communication system;

FIG. 2 is a flow chart showing a link adaptation algorithm that may be implemented by the system of FIG. 1;

FIG. 3 is a block diagram of a system in accordance with an example embodiment;

FIGS. 4 and 5 are flow charts showing algorithms in accordance with example embodiments;

FIG. 6 is a block diagram of a neural network used in some example embodiments;

FIG. 7 is a flow chart showing an algorithm in accordance with an example embodiment;

FIG. 8 shows plots of simulation results in accordance with example embodiments;

FIG. 9 is a block diagram of components of a system in accordance with an example embodiment; and

FIG. 10 shows tangible media storing computer-readable code which when run by a computer may perform methods according to example embodiments described above.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

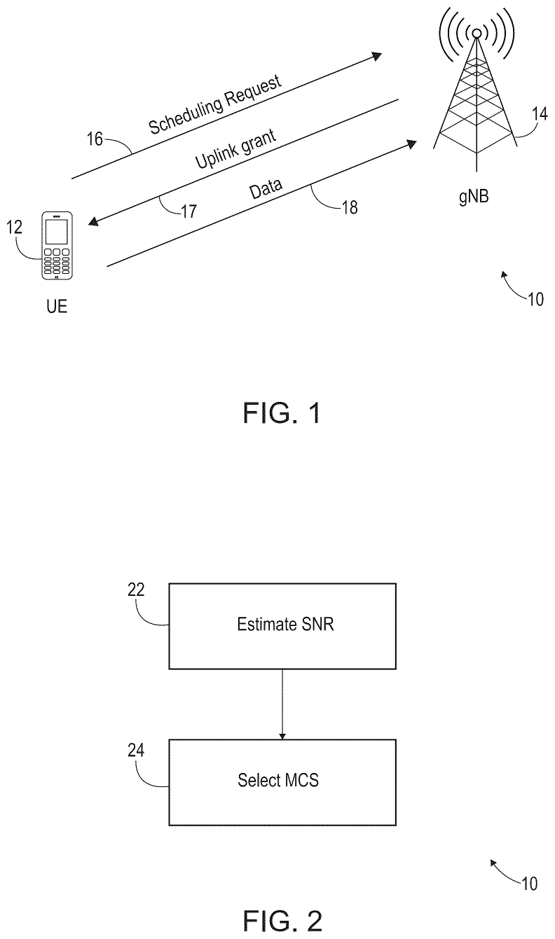

FIG. 1 is a block diagram of a mobile communication system, indicated generally by the reference numeral 10. The system 10 comprises a user device 12 and a node 14 of a mobile communication system. The user device 12 may be a user equipment (UE) and the node 14 may be a base station/next generation node B (BS/gNB).

When the user device 12 wishes to send data to the node 14, the user device makes a scheduling request 16. The scheduling request 16 may be made on a physical random access channel (PRACH) for the first time, or on a physical uplink control channel (PUCCH) if already scheduled.

In response to the scheduling request 16, the node 14 sends an uplink grant message 17 in a downlink control information (DCI) message with information identifying physical resource blocks (PRB) to use, and specifying a modulation and coding scheme (MCS) for use for data transmission.

Following receipt of the uplink grant message 17, the user device 12 sends data using the defined MCS on the physical uplink shared channel (PUSCH), as indicated by the message 18 in FIG. 1. This process is part of a link adaptation (LA) algorithm, whereby the node 14 adapts the MCS based, for example, on the capacity that is supported by the link between the user device 12 and said node 14.

FIG. 2 is a flow chart showing an algorithm, indicated generally by the reference numeral 20 that may be implemented by the system of FIG. 1. The algorithm 20 may be implemented at the node 14 of the system 10.

The algorithm 20 starts at operation 22, where a signal-to-noise ratio (SNR) for communications between the user device 12 and the node 14 is estimated. At operation 24, a modulation and coding scheme (MCS) is selected based on the estimated SNR.

In single-user (SU) single-input single-output (SISO) systems, the node 14 of the system may use an algorithm such as the algorithm 20 to determine an MCS level based on the estimated signal-to-noise ratio (SNR) or the signal-to-interference-noise ratio (SINR). However, as discussed further below, for MU-MIMO systems that use non-linear detectors at the network node/base station, such a post-processed equivalent SNR/SINR does not exist. Thus, the algorithm 20 is not applicable to such systems.

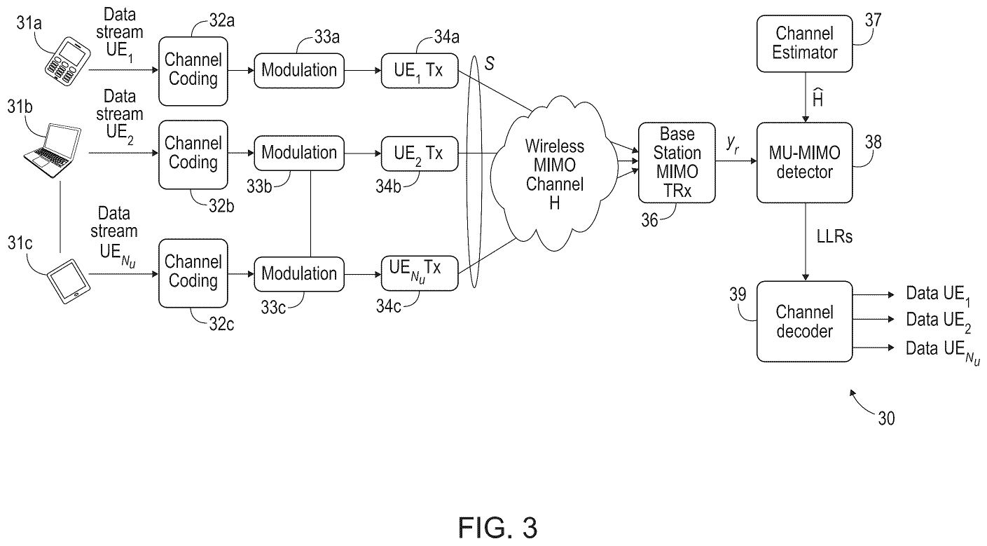

FIG. 3 is a block diagram of a system, indicated generally by the reference numeral 30, in accordance with an example embodiment. The system 30 is an uplink MU-MIMO system.

The MU-MIMO system 30 comprises a first user device 31a generating a first data stream UE₁, a second user device 31b generating a second data stream UE₂ and a third user device 31c generating a third data stream UE_{Nu}. (Note that in this document the user devices or the respective data streams may be referred to using the reference UEₓ.)

Of course, three user devices creating three data streams is shown by way of example only—any number of user devices may be used (hence the use of the term Nᵤ user devices in FIG. 3).

The system 30 comprises a first channel comprising a first channel coding module 32a, a first modulation module 33a and a first transmitter module 34a; the first channel coding module 32a and the first modulation module 33a implement a first MCS that is applied to the first data stream UE₁. The system 30 further comprises a second channel comprising a second channel coding module 32b, a second modulation module 33b and a second transmitter module 34b; the second channel coding module 32b and the second modulation module 33b implement a second MCS that is applied to the second data stream UE₂. Similarly, the system 30 comprises a third channel comprising a third channel coding module 32c, a third modulation module 33c and a third transmitter module 34c; the third channel coding module 32c and the third modulation module 33c implement a third MCS that is applied to the third data stream UE_{Nu}.

The outputs of the transmitter modules 34a, 34b and 34c provide a transmission signal s that is transmitted over a wireless communication channel 35 to a base station. As indicated in FIG. 3, the channel 35 can be described by a channel matrix H.

The base station of the system 30 comprises a base station transceiver 36, a channel estimator 37, a MU-MIMO detector 38 and a channel decoder 39.

The base station transceiver 36 receives signals from the channel 35 and generates a baseband signal yᵣ that is provided to the MU-MIMO detector 38 for processing. The channel estimator 37 generates an estimate Ĥ of the channel 35 and provides that estimate to the MU-MIMO detector 38.

The task of the MU-MIMO detector 38 is to generate log-likelihood ratios (LLRs) for each transmitted bit for each user. A popular MU-MIMO detector in usage is the linear minimum mean squared error (LMMSE) detector. Linear detectors are simple from a computational complexity point-of-view. LMMSE, or any linear detector in general, enables a MU-MIMO system to be split into several SU-SISO systems, and for such systems, there have been plenty of techniques in the literature that map the resulting equivalent SNR/SINR to an MCS level.

As noted above, for SU-SISO systems, SNR/SINR is a metric that enables the adaptation of the MCS level. However, non-linear MU-MIMO detectors provide more system throughput than linear detectors. An example of such a non-linear detector is the K-best list search decoder (LSD). Unlike with the case of linear detectors, there is no known technique to obtain an equivalent SNR for each stream with the case of non-linear detectors. This means that the known link adaptation techniques in the literature cannot be applied to MU-MIMO systems with non-linear detectors.

Moreover, the ideal MCS levels for a single user (without MU-MIMO) are significantly different from the ideal MCS levels seen by the same user in a MU-MIMO system even if the transmit power is the same. This is due, at least in part, to the interference caused by other users.

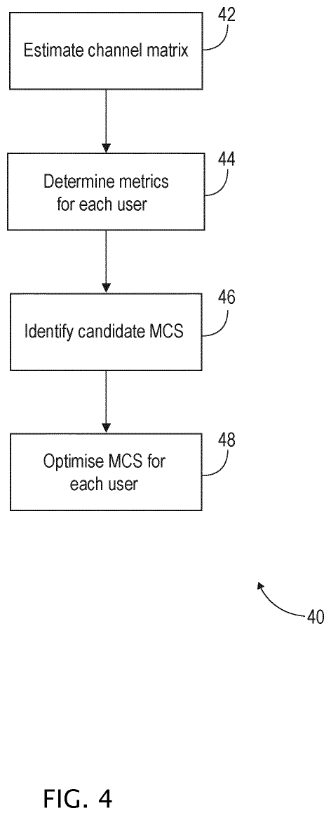

FIG. 4 is a flow chart showing an algorithm, indicated generally by the reference numeral 40, in accordance with an example embodiment. The algorithm 40 may be implemented using the system 30.

The algorithm 40 starts at operation 42, where an estimate of the channel 35 of the MU-MIMO system 30 is generated by the channel estimator module 37. As discussed above, the channel estimate may take the form of an estimated channel matrix Ĥ.

At operation 44 of the algorithm 40, a metric for each of a plurality of available modulation orders is determined for each of a plurality of transmitting channels of said communication system. The metrics may be determined based on the estimated channel (as generated in the operation 42). As discussed further below, the metrics determined in the operation 44 may be bit metric decoding rates (BMDRs) or metrics having a one-to-one relationship with bit-metric decoding rates. For example, one BMDR may be determined for each modulation order.

At operation 46, one or more modulation and coding schemes (MCS) are identified for each transmitting channel for which the metric predicted in operation 44 meets a target error rate criterion. Each modulation and coding scheme comprises a modulation order and a code rate of a channel code.

At operation 48, a modulation and coding scheme is selected for each of said transmitting channels from the modulation and coding schemes identified in the operation 46. As discussed in detail below, the operation 48 may be implemented as a joint optimisation problem.

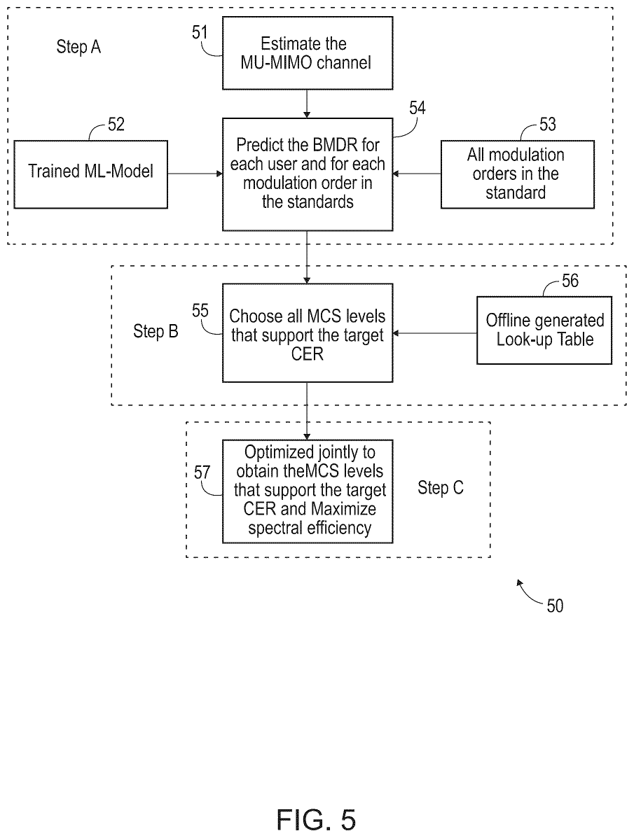

FIG. 5 is a flow chart showing an algorithm, indicated generally by the reference numeral 50, in accordance with an example embodiment. The algorithm 50 provides more detail of an example implementation of the algorithm 40.

The algorithm 50 comprises a first part (step A) in which an estimate of the MU-MIMO channel is generated and used to predict a metric (BMDR) for each of a plurality of available modulation orders for each of a plurality of transmitting channels of said communication system. Accordingly, the first part of the algorithm 50 may implement the operations 42 and 44 of the algorithm 40.

In the first part of the algorithm 50, a channel estimate is generated in operation 51 (e.g. by a channel estimator module, such as the channel estimator 37) and is used as input to an operation 54 in which a prediction is made, for each of a plurality of transmitting users, of a plurality of metrics using a machine-learning model. In the algorithm 50, the metrics are a bit-metric decoding rate (BMDR) or some other metric with a one-to-one relationship with BMDR. The operation 54 is therefore an example of the operation 44 described above. The operation 54 may be implemented by a prediction module.

The operation 54 receives details of a trained machine-learning model (from operation 52) and details of all modulation orders in the relevant standard (from operation 53). By way of example, there are four modulation orders in 5G—4-QAM, 16-QAM, 64-QAM and 256-QAM. It should be noted that although a trained ML model is used in the algorithm 50, this is not essential for all example embodiments. For example, in the event that linear detectors are used, it may be possible to provide solutions in which ML models are not used.

The plurality of metrics for each user generated in the operation 54 consist of one metric for each modulation order in the relevant standard.

The second part (step B) of the algorithm 50 identifies modulation and coding scheme (MCS) levels for each transmitting channel for which a metric predicted in step A meets a target error rate criterion.

In operation 55 of the algorithm 50, an offline-generated look-up table is used to identify, for each of the plurality of users, those modulation and coding schemes (MCS) for which the predicted metrics (BMDR) meet a target error rate criterion. In the example algorithm 50, the target error criterion is a target codeword error rate (CER); alternative criteria exist, such as block error rate. The operation 55 may be implemented using a selection module.

As discussed in detail below, the ML model (provided in the operation 52) is used to predict the BMDR and to provide the predicted BMDR to an operation 55 of step B. The operation 55 maps the BMDRs predicted in the operation 52 to the possible achievable codeword error rates provided by the look-up table generated in operation 56, and thus identifies which of the available MCS levels can be used for reliable transmission.

Step B is therefore an example implementation of the operation 46 of the algorithm 40.

The third part (step C) of the algorithm 50 selects a modulation and coding scheme level for each of said transmitting channels from the modulation and coding schemes identified in step B. By way of example, an operation 57 may optimize jointly among all the identified MCS levels for all users (as output by the operation 56) to obtain the best MCS levels for the set of transmitting users that maximize the spectral efficiency across the transmitting channels. The operation 57 may be implemented by an optimisation module.

Step C is therefore an example implementation of the operation 48 of the algorithm 40.

Further details of the principles described above are provided below.

### Channel Model

In the discussion below, we focus on the uplink MU-MIMO scenario but a generalization to the downlink, or to any other wireless data transmission between two terminals is possible.

Let {UE₁, UE₂, . . . , UE_{N}_{ᵤ}} be the Nᵤ user devices (UEs) scheduled in a given transmission time interval (TTI) in a given cell in the uplink in MU-MIMO mode (i.e., these UEs are scheduled on the same resource blocks).

Let Nᵣ be the number of received (Rx) inputs at the base station/gNB and Nₜ⁽ⁱ⁾ be the number of transmit antennas at UEᵢ, i=1,2, . . . , Nᵤ. Further, let N=ΣᵢNₜ⁽ⁱ⁾.

Let us denote an MCS level by the pair (q,r), where q denotes the modulation order (or the size of the constellation), and r denotes the code rate of the channel code used. The spectral efficiency of the MCS level is r log₂ q bits. Let [symbol] denote the set of all possible MCS levels (defined by the pair (q,r)), [symbol] denote the set of all modulation orders, and [symbol] denote the set of all code rates.

We assume that UEᵢ transmits Nₜ⁽ⁱ⁾ number of modulated data streams (which we also refer to as “layers”). We assume that Nᵣ≥N. Assume that UE i employs a QAM constellation [symbol] . The size of [symbol] is qᵢ and [symbol] is a Cartesian product of two PAM constellation of size √qᵢ each, denoted by [symbol] .

Let Hᵢ be the Nᵣ×Nₜ⁽ⁱ⁾ channel matrix representing the channel between UEᵢ and the BS (including the effect of the precoding matrices, if used). Let

$${y}_{r} = H s + {n}_{int} + {n}_{A W G N} \qquad ( 1 )$$

where yᵣ∈ [symbol] is the signal received at the BS from all the UEs, H=[H₁. . . H_{N}_{ᵤ}]∈ [symbol] is the concatenated channel matrix, n_{AWGN} is the additive white Gaussian noise at the receiver, nᵢₙₜ is the co-channel interference from other cells, and

$$s = {[ {s}_{1}^{T} , {s}_{2}^{T} , … , {s}_{{N}_{u}}^{T} ]}^{T} ∈ {Q}^{N \times 1} {=}^{def} {Q}_{1}^{{N}_{t}^{( 1 )} \times 1} \times {Q}_{2}^{{N}_{t}^{( 2 )} \times 1} \times … \times {Q}_{{N}_{u}}^{{N}_{t}^{( {N}_{u} )} \times 1}$$

is the cumulative signal vector transmitted by all the Nᵤ UES.

The pre-processing stage may consist of:
Noise-whitening: Channel estimation is performed to get Hₑₛₜ as the estimate of the channel H. After the estimation of the estimation error-covariance and the interference plus noise covariance, whitening is performed. The result is:

$$\hat{y} = \hat{H} s + \overline{n} \qquad ( 2 )$$

where, due to whitening, the effective noise and interference term n̅ is now approximately transformed into white noise with variance 1 per complex dimension. Note that Ĥ is dependent on Hₑₛₜ and the whitening matrix.
Complex to real: The model in (2) is converted to its real equivalent to obtain

$$\tilde{y} = \tilde{H} \tilde{s} + \tilde{n} \qquad ( 3 )$$

where \tilde{y}∈ [symbol] , \tilde{H}∈ [symbol] , \tilde{s}∈ [symbol] , ñ∈ [symbol] is real AWGN.
QR decomposition: The QR decomposition of \tilde{H} is performed to obtain \tilde{H}=QR where Q∈ [symbol] is orthogonal and R∈ [symbol] is upper-triangular. Next, we obtain

$$y {=}^{def} {Q}^{T} \overline{y}$$

to get:

$$y = R {s}_{R} + n , y ∈ {ℝ}^{2 N \times 1} , R ∈ {ℝ}^{2 N \times 2 N} , {s}_{R} ∈ {𝒫}^{2 N \times 1} , n ∈ {ℝ}^{2 N \times 1} \qquad ( 4 )$$

where n=Q^{T}ñ continues to be white due to the orthogonality of Q, and

$${𝒫}^{2 N \times 1} {=}^{def} {𝒫}_{1}^{{N}_{t}^{( 1 )} \times 1} \times {𝒫}_{1}^{{N}_{t}^{( 1 )} \times 1} \times {𝒫}_{2}^{{N}_{t}^{( 2 )} \times 1} \times … \times {𝒫}_{{N}_{u}}^{{N}_{t}^{( {N}_{u} )} \times 1} ,$$

the Cartesian product of PAM constellations.

### Bit-Metric-Decoding Rate (BMDR)

since UEᵢ transmits Nₜ⁽ⁱ⁾ symbols from a qᵢ-QAM,

$${n}_{i} {=}^{def} {N}_{t}^{( i )} {log}_{2} {q}_{i}$$

bits are encoded per transmission. Let the vector of these bits be denoted by bᵢ=[b_{1,i}b_{2,i}, . . . , bₙ_{ᵢ}_{,i}]. Further,

$$let q {=}^{def} \{ {q}_{1} , {q}_{2} , … , {q}_{{N}_{u}} \}$$

be the set of modulation orders used by all the users. The set of all possible combinations for [symbol] is denoted by [symbol] . For example, if only 4-QAM and 16-QAM are available for a 2-user system with a single antenna at each user, then [symbol] ={{4,4}, {4,16}, {16,4}, {16,16}}. Now, conditioned on the effective channel Ĥ for the model given by (2), the BMDR [symbol] ( [symbol] , Ĥ) associated with a MIMO detector [symbol] for UEᵢ may be defined as:

$${R}_{D , i} ( q , \hat{H} ) {=}^{def} 1 - {𝔼}_{\hat{y}} \{ \frac{1}{{n}_{i}} {\sum }_{k = 1}^{{n}_{i}} C E ( {b}_{k , i} , σ ( L L {R}_{𝒟} ( {b}_{k , i} , \hat{H} ) ) ) \vert \hat{H} \} \qquad ( 5 )$$

where [symbol] (b_{k,i}, Ĥ) is the log-likelihood ratio (LLR) for the k^{th} bit of User i using the detector [symbol] , σ(.) is the sigmoid function, and CE(.) is the binary cross entropy function, respectively given as:

$$LL {R}_{𝒟} ( {b}_{k , i} , \hat{H} ) {=}^{def} log [ \frac{P r ( {b}_{k , i} = 1 \vert {y}_{r} , \hat{H} )}{P r ( {b}_{k , i} = 0 \vert {y}_{r} , \hat{H} )} ] , \qquad ( 6 )$$

$$σ ( x ) {=}^{def} \frac{1}{1 + exp ( - x )} , \qquad ( 7 )$$

$$CE ( a , b ) {=}^{def} - a log b - ( 1 - a ) log ( 1 - b ) . \qquad ( 8 )$$

In (5), [symbol] {.} denotes the expectation over ŷ, which means the expectation is over the noise n̅ and the symbol vector s. It can be seen that the BMDR of a user in a MU-MIMO system is a value less than 1 and depends on the following:
The composite MU-MIMO channel matrix Ĥ (this is evident from (5)).
The modulation orders qᵢ of all the users. This is not obvious at first glance, but from the fact that the expectation in (5) is also over the symbol vector s.
The variance of the noise n̅ (which is unity in this case due to the pre-processing).

### Relationship Between BMDR, Code Rate, and CER

Suppose that a codeword of length nᵢ for UEᵢ is transmitted over n_{RE,i} resources elements, and the received and processed signal vectors (with reference to (2)) are given as ŷⱼ=Ĥⱼs+n̅ⱼ, j=1, . . . , n_{RE,i}.

Further, let

$${ℋ}_{i} {=}^{def} \{ {\hat{H}}_{j} , j = 1 , … , {n}_{RE , i} \} ,$$

the set of all observed channels over with UEᵢ transmits its codeword. Here, we use the subscript to denote that this is from the perspective of UEᵢ. Also, let the code rate of the channel code be rᵢ∈(0,1] and the MU-MIMO detector used be denoted by [symbol] . Let

$${R}_{i} ( q , {ℋ}_{i} ) {=}^{def} \frac{1}{{n}_{RE , i}} {\sum }_{j = 1}^{{n}_{RE , i}} {R}_{𝒟 , i} ( q , {\hat{H}}_{j} ) . \qquad ( 9 )$$

Then, the probability that the codeword is in error is bounded as follows:

$${P}_{e} \leq {2}^{- {n}_{i} ( {R}_{i} ( q , {ℋ}_{i} ) - δ - {r}_{i} )} + {e}^{- \frac{{n}_{i} {δ}^{2}}{c}} \qquad ( 10 )$$

where C is some positive constant and δ>0 is called the margin.

Equation 10 captures the relationship between the BMDR, the code rate and the CER. The margin δ decides the required level of gap between Rᵢ( [symbol] , [symbol] ) and rᵢ for a target CER.

### Example Implementation

The description above provides the theory behind the relationship between the CER and BMDR once a codeword has been transmitted. For the purpose of MCS selection for a user in a MU-MIMO system, the base station/gNB may make an estimate of Rᵢ( [symbol] , [symbol] ) given in (9) for every [symbol] ∈ [symbol] , and then jointly perform the link adaptation for all the users. Moreover, this may be done without having observed the actual set of channels over which the codeword will be transmitted. For this, sounding reference signal (SRS) based channel estimation may be used (for the co-scheduled MU-MIMO channel), and then a prediction of Rᵢ( [symbol] , [symbol] ) may be made for each User i, and for each [symbol] ∈ [symbol] .

In practice, the SRS-based channel estimate (taken over a few resource elements) is generally a good representation of the actual channel over which data is transmitted. Another possibility for the case where the users are static and are already communicating with the base station/gNB is to use the channel estimates of the previous transmission slot. Assuming the first option, we denote the set of the SRS-based channel estimates by [symbol] . Note from (5) that the BMDR has no dependency on the code rate. Therefore, we only need to predict Rᵢ( [symbol] , [symbol] ) for each ( [symbol] ∈ [symbol] and then choose the MCS level that maximizes the spectral efficiency for a given target CER (or block error rate (BLER) which is directly computable from the CER) for all the users. This means that one possible way to compute the MCS levels (defined by the pair (qᵢ^{*}, rᵢ^{*}) for the i^{th} user) jointly for all the users is by solving the following simple optimization problem:

$$\{ ( {q}_{i}^{*} , {r}_{i}^{*} ) , i = 1 , … , {N}_{u} \} = {argmax}_{( {q}_{i} , {r}_{i} ) ∈ 𝕄 , i = 1 , … , {N}_{u}} \{ {\sum }_{i = 1}^{{N}_{u}} {r}_{i} {log}_{2} {q}_{i} \vert \begin{matrix}{R}_{i} ( q , {ℋ}_{SRS} ) > {r}_{i} + δ ( {r}_{i} ) , ∀ i = 1 , … , {N}_{u} , \\ q = \{ {q}_{1} , … , {q}_{{N}_{u}} \}\end{matrix} \} \qquad ( 11 )$$

where δ (rᵢ) is the minimum margin required for a target CER/BLER for the code rate rᵢ. To put into words, “Rᵢ( [symbol] , [symbol] )>rᵢ+δ(rᵢ)” is a mathematical way of saying that the code rate rᵢ should be such that a target CER/BLER is guaranteed. To obtain this margin, we need a look-up table, and a method to generate this is discussed further below.

Now, the BMDR in (9) is not straightforward to compute because there is no closed form expression for the per channel BMDR given by (5). Therefore, a machine-learning approach may be used, for example using a trained convolutional neural network (CNN) to estimate the BMDR for a channel realization, as discussed further below.

### Example Illustration

An illustration of a use of the principles described herein is provided below.

Assume that a system similar to the system 30 includes four single-antenna users, with available modulation orders 2, 4 and 6 (e.g. 4/16/64 QAM modulation schemes).

The following gives an example use of the algorithms 40 and 50 (with example data) to set MCS levels:
1. Set the modulation order (mᵢ) as: mᵢ=6, i=1,2,3,4
2. Estimate [symbol] ( [symbol] , (6,6,6,6), i=1,2,3,4 using sounding reference signal (SRS) estimated channels or previous DMRS estimated channels (if the same scheduling is used)
3. In this example, the BMDR estimates (see operation 54 of the algorithm 50) are: 0.60, 0.74, 0.40, 0.10.
4. From the look-up table (see the operation 56), the following target BMDRs for 64-QAM and MCS 17-28 are obtained:
   [17:0.52, 18:0.54, 19:0.59, 20:0.64, 21:0.68, 22:0.73, 24:0.83, 25:0.87, 26:0. 90, 27:0.94, 28:0.97].
5. Choosing the highest MCS levels that support the target CER (operation 57) results in the selection of MSC 19 for user 1 and MCS 22 for user 2. Users 3 and 4 are not supported by 64-QAM.
6. Set m₁=6, m₂=6, m₃=4, m₄=4. Estimate [symbol] ( [symbol] , (6,6,4,4)), i=1,2,3,4.
7. In this example, the BMDR estimates are: 0.56, 0.72, 0.64, 0.28.
8. From the look-up table, the following target BMDRs for 16-QAM and MCS 10-16 are obtained:
   [10:0.41, 11:0.46, 12:0.51, 13:0.56, 14:0.63, 15:0.69, 16:0.71].
9. Choosing the highest MCS levels that support the target CER results in the selection of MSC 14 for user 3. User 4 is not supported by 16-QAM.
10. Set m₁32 6, m₂=6, m₃=4, m₄=2. Estimate [symbol] ( [symbol] , (6,6,4,2)), i=1,2,3,4.
11. In this example, the BMDR estimates are: 0.56, 0.72, 0.62, 0.47.
12. From the look-up table, the following target BMDRs for 4-QAM and MCS 0-9 are obtained:
   [0:0.19, 1:0.23, 2:0.26, 3:0.32, 4:0.38, 5:0.46, 6:0.53, 7:0.60, 8:0.67, 9: 0.75].
13. Choosing the highest MCS levels that support the target CER results in the selection of MSC 5 for user 4.

### Example ML Model

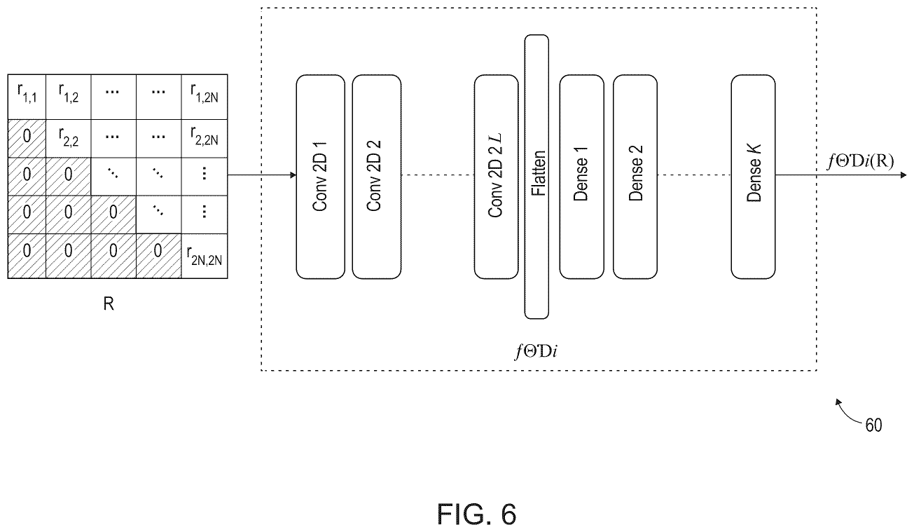

FIG. 6 is a block diagram of a neural network, indicated generally by the reference numeral 60, used in some example embodiments. More specifically, the neural network 60 is a convolutional neural network (CNN) architecture that may be used for predicting BMDR in an example embodiment.

The CNN 60, denoted by [symbol] performs the prediction of the BMDR for UEᵢ and for Detector [symbol] . Using the subscript j to index the REs over which the codeword of UEᵢ is transmitted, the input to the CNN is the R-matrix obtained in (4) and denoted by Rⱼ, and [symbol] (Rⱼ) is an estimation of [symbol] ( [symbol] , Ĥⱼ) using the trained CNN for a constellation combination given by [symbol] .

The CNN 60 is described by way of example only. A number of variants to the CNN 60 are possible, such as different configurations of layers. Moreover, the skilled person will be aware of alternative machine-learning models that could be used in other example embodiments.

### Look-Up Table Generation

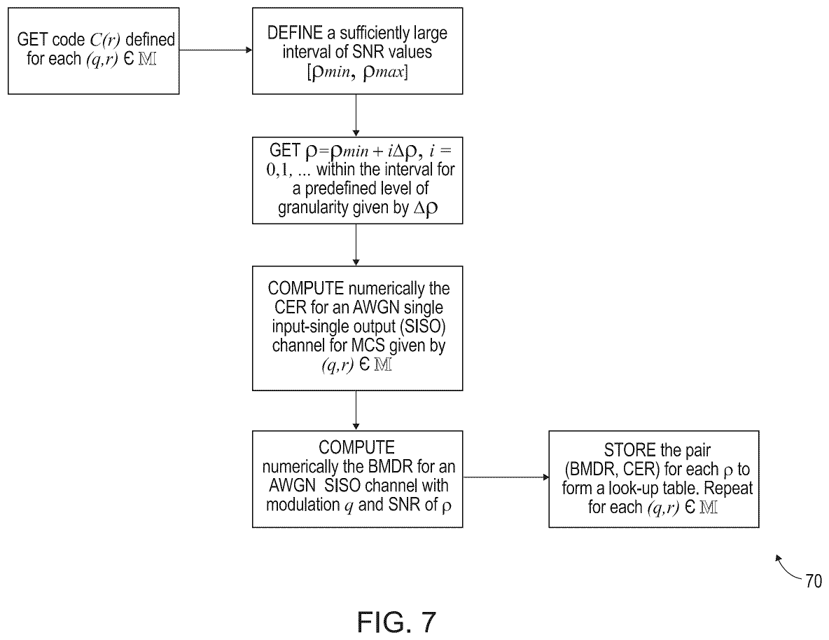

FIG. 7 is a flow chart showing an algorithm, indicated generally by the reference numeral 70, in accordance with an example embodiment. The algorithm 70 shows an example method for generating a look-up table for use in mapping estimate BDMR to a CER value for a codeword transmission. Thus, the algorithm 70 may be used to generate the look-up table referred to in the operation 56 described above.

In the algorithm 70, [symbol] (r) refers to the code whose rate r is defined for each modulation and coding scheme (MCS) level in 5G (or any other standard in context). Since most codewords have a maximum message length nₘₐₓ (8448 and 3840 in 5G depending on the MCS level), these message lengths can be used to generate the look-up table.

It has been observed from simulations that the BMDR vs CER curve for an AWGN channel is approximately independent of the modulation order (the size of the QAM constellation used) and is only dependent on the code rate. Thus, BMDR to CER mapping is approximately independent of the detector scheme used and the modulation order used, and only depends on the code rate.

### Simulation Results

A dataset of channel realizations was generated from the 3GPP 38,901 UMa NLOS scenario using the QuaDRiGa channel simulator. We considered a base station (BS) equipped with a rectangular planar array consisting of 16 (2 vertical, 8 horizontal) antennas installed at a height of 25 m and an antenna spacing of 0.5λ where 2 is the carrier wavelength. The BS has a coverage angle of 120° and a coverage radius of 250 m. Within this coverage sector, the region within a distance of 25-250 m from the BS is considered for the random placement of 4 single-antenna users (Nᵤ=4). Once a user is dropped at a particular position, it is then assumed to move along a linear trajectory for three speeds—a) 1-5 kmph b) 18-35 kmph c) 40-60 kmph. Channels are sampled every 35.7 μs at a center frequency of 3.5 GHz to obtain sequences of length 70 (corresponds to 5 slots of 14 symbols each in 5G NR). Each channel realization is then converted to the frequency domain assuming a bandwidth of 2.16 MHz and 72 sub-carriers with a subcarrier spacing of 30 kHz, i.e., 6 physical resource blocks (PRBs) in 5G NR. A total of 400 independent user drops were obtained for each user speed range, resulting in 400×70×72 =2.016 million channel matrices of size 16×4 arranged as arrays of dimensions (400, 72, 70, 16, 4) each for every speed range. Since the pathloss can vary dramatically between different users, we assumed perfect power control per slot of 14 symbols.

The CNN 60 described above was trained on 50% of the channel matrices for user speeds between 18-35 kmph and tested on other user speeds using the architecture summarized below. We considered the K-best detector (K=32) as our choice non-linear MU-MIMO detector, and trained 4 different CNNs, one for each user and for 16-QAM.

| Layer (type) | Output Shape | Param # |
|---|---|---|
| input_1 (InputLayer) | [(None, 8, 8, 1)] | 0 |
| Conv2D_2 (Conv2D) | (None, 8, 8, 8) | 40 |
| Conv2D_3 (Conv2D) | (None, 7, 7, 4) | 132 |
| Flatten (Flatten) | (None, 196) | 0 |
| Dense_2 (Dense) | (None, 4) | 788 |
| output1 (Dense) | (None, 1) | 5 |

Total params: 965
Trainable params: 965
Non-trainable params: 0

To show that the proposed technique is useful in theory, we made the BMDR estimates on the estimated channels (perfect estimation is assumed here) in the previous codeword slot, and made a decision on the code rate to be used for the transmission of a codeword in the next time-slot. We only assumed 16-QAM in our simulations, and supposed that due to a good power control, the average received signal powers of all the users are approximately equal. This is an idealistic scenario but sufficient for our purpose. The goal is to adapt the code rate of transmission to achieve a target CER less than 10^{-2.} The choice of code rates in our simulation were restricted to only the following four:—rate 1/5, rate 1/3, rate 1/2, and rate 2/3.

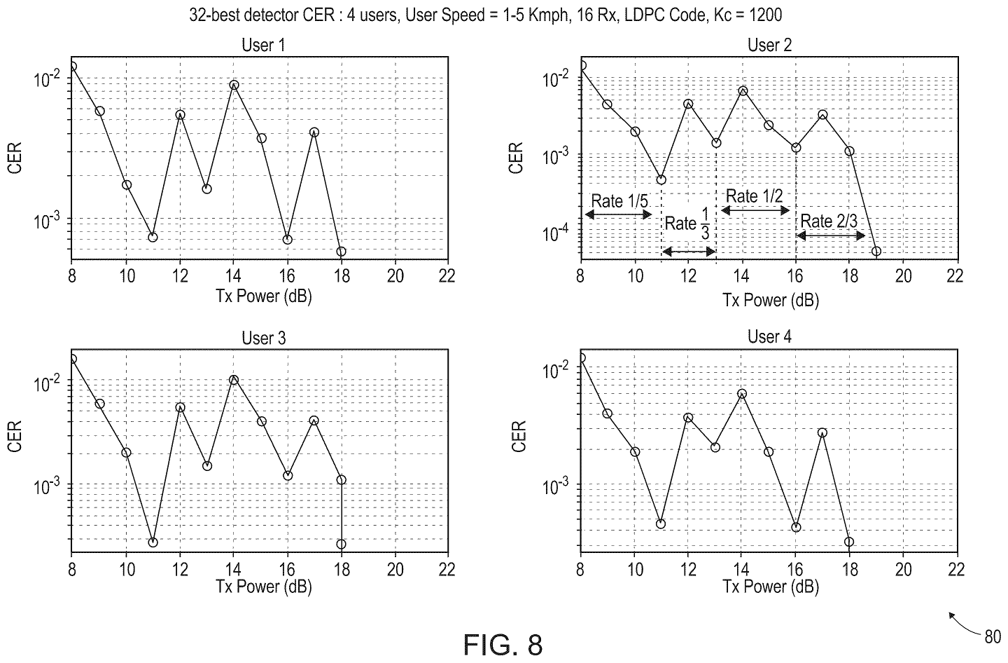

FIG. 8 shows plots, indicated generally by the reference numeral 80, of simulation results in accordance with example embodiments.

FIG. 8 shows the CERs of the four users as a function of the user transmit power. For each power level, 10k codewords were transmitted per user using the channels generated by QuaDRiGa for user speeds in the range 1-5 kmph. As mentioned earlier, the BMDR estimates were made for the channels in the current codeword transmission duration and used to select the appropriate code-rate for the next codeword transmission. We used 5G LDPC codes with message length 1200 for our simulations.

It can be observed that as the power levels increase, the scheme progressively selects higher rate codes (marked in the top-right figure for the CER of User 2), but the overall CER is maintained to be at most 10^{-2.} In practical systems, one will have different transmit powers for different users, different MCS needs for different users, imperfect channel estimates, and a few other imperfections. However, our simulations show that the BMDR estimates are quite accurate for link adaptation in our considered scenario, analogous to the way SINR is useful for SU systems with linear detectors.

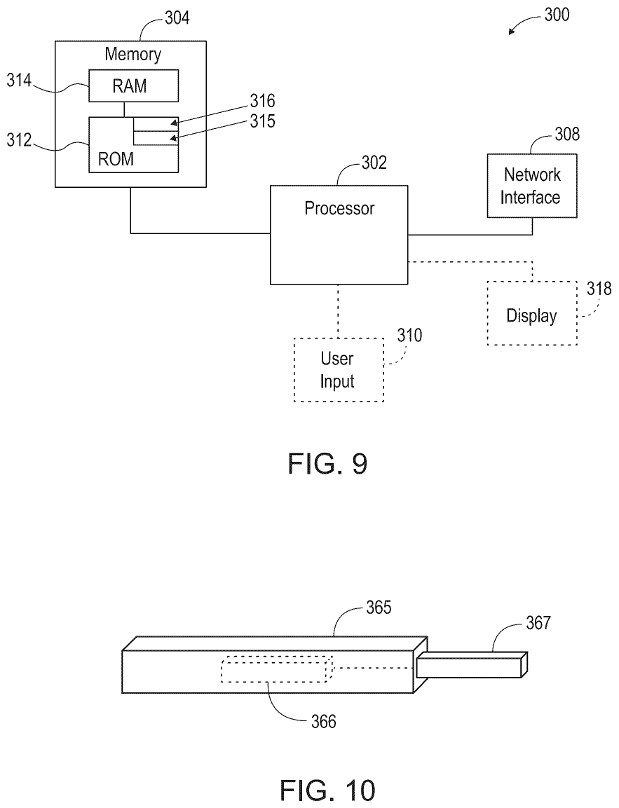

For completeness, FIG. 9 is a schematic diagram of components of one or more of the example embodiments described previously, which hereafter are referred to generically as a processing system 300. The processing system 300 may, for example, be (or may include) the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The

RAM 314 of the memory 304 is used by the processor 302 for the temporary storage of data. The operating system 315 may contain code which, when executed by the processor implements aspects of the algorithms 20, 40, 50 and 70 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 10 shows tangible media, specifically a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 2, 4, 5 and 7 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising
at least one memory configured to store computer program code; and
at least one processor configured to execute the computer program code and cause the apparatus to perform,
estimating a channel of a multi-user multiple-input-multiple-output mobile communication system;
determining, based on the estimated channel, a metric for each of a plurality of available modulation orders for each of a plurality of transmitting channels of said communication system;
identifying, for each transmitting channel, one or more modulation and coding schemes for which the predicted metric meets a target error rate criterion, wherein each modulation and coding scheme comprises a modulation order and a code rate of a channel code; and
selecting a modulation and coding scheme for each of said transmitting channels from said identified modulation and coding schemes.

2. The apparatus as claimed in claim 1, wherein said metrics comprise bit metric decoding rates or metrics having a one-to-one relationship with bit-metric decoding rates.

3. The apparatus as claimed in claim 1, wherein the metrics are determined using a machine learning model.

4. The apparatus as claimed in claim 1, wherein said one or more modulation and coding schemes are identified using a lookup table.

5. The apparatus as claimed in claim 1, wherein the modulation and coding schemes are selected jointly for said transmitting channels.

6. The apparatus as claimed in claim 1, wherein the modulation and coding schemes are selected based on an optimisation of spectral efficiency across the transmitting channels.

7. The apparatus as claimed in claim 1, wherein said available modulation orders comprise all modulation orders of a communications standard being implemented by the communication system.

8. The apparatus as claimed in claim 1, wherein the transmitting channels relate to transmitter user devices of the communication system.

9. The apparatus as claimed in claim 1, wherein the target error rate criterion comprises a codeword error rate criterion or a block error rate criterion.

10. The apparatus as claimed in claim 1, wherein the multi-user multiple-input-multiple-output mobile communication system comprises a non-linear detector.

11. (canceled)

12. A method comprising:
estimating a channel of a multi-user multiple-input-multiple-output mobile communication system;
determining, based on the estimated channel, a metric for each of a plurality of available modulation orders for each of a plurality of transmitting channels of said communication system;
identifying, for each transmitting channel, one or more modulation and coding schemes for which the predicted metric meets a target error rate criterion, wherein each modulation and coding scheme comprises a modulation order and a code rate of a channel code; and
selecting a modulation and coding scheme for each of said transmitting channels from said identified modulation and coding schemes.

13. The method as claimed in claim 12, wherein:
the metrics are determined using a machine learning model; and/or
said one or more modulation and coding schemes are identified using a lookup table.

14. The method as claimed in claim 12, wherein:
the modulation and coding schemes are selected jointly for said transmitting channels; and/or
the modulation and coding schemes are selected based on an optimisation of spectral efficiency across the transmitting channels.

15. A non-transitory computer-readable medium storing computer program code, which when executed by a processor, cause an apparatus including the processor to perform
estimating a channel of a multi-user multiple-input-multiple-output mobile communication system;
determining, based on the estimated channel, a metric for each of a plurality of available modulation orders for each of a plurality of transmitting channels of said communication system;
identifying, for each transmitting channel, one or more modulation and coding schemes for which the predicted metric meets a target error rate criterion, wherein each modulation and coding scheme comprises a modulation order and a code rate of a channel code; and
selecting a modulation and coding scheme for each of said transmitting channels from said identified modulation and coding schemes.
